(19) United States
(12) Patent Application Publication
(10) Pub. No.: US 2026/0008303 A1
(43) Pub. Date: Jan. 8, 2026

(54) VEHICLE WHEEL TYRE

(71) Applicant: PIRELLI TYRE S.P.A., Milano (IT)

(72) Inventors: Giovanni CASAROTTO, MILANO (IT); Riccardo GUERRA, MILANO (IT); Diego Ettore SPEZIARI, MILANO (IT)

(21) Appl. No.: 18/881,694

(22) PCT Filed: Jun. 27, 2023
(86) PCT No.: PCT/IB2023/056623

§ 371 Date: Jan. 6, 2025

(30) Foreign Application Priority Data
Jul. 27, 2022 (IT) 102022000015927

(51) Int. Cl. B60C 11/12

(52) U.S. Cl. CPC B60C 11/1204; B60C 11/1236; B60C 2011/1213

(57) ABSTRACT

A tyre includes a plurality of blocks which are defined on a tread band and at least one first sipe which is formed on each block. The first sipe extends in a first longitudinal direction and includes a first linear portion which substantially extends along the first longitudinal direction, a single-wave portion which extends in continuation of the first linear portion, and a second linear portion which extends in continuation of the single-wave portion. The single-wave portion includes a first segment which extends from the first linear portion as far as a first peak, a second segment which extends from the first peak as far as an opposite second peak and a third segment which extends from the second peak as far as the second linear portion. The angle of inclination of second segment is greater than that of the first segment and the third segment.

The present invention relates to a tyre for vehicle wheels, in particular a winter tyre.

A tyre generally comprises a carcass structure which is toroidally shaped about a rotation axis, and which comprises at least one carcass ply which has end edges which are engaged in respective annular anchoring structures, called bead cores.

In a radially external position with respect to the carcass structure, there is provided a belt structure comprising, in the case of tyres for cars, at least two radially overlapping strips of rubberized fabric which is provided with reinforcement cords, which are usually made of metal, and which are arranged in each strip parallel with each other but crosswise with respect to the cords of the adjacent strip, preferably symmetrically with respect to the equatorial plane of the tyre.

Preferably, the belt structure also further comprises, in a radially outer position at least on the ends of the underlying belt strips, a third layer of textile or metal cords, arranged circumferentially (at 0 degrees). In tyres of the tubeless-type, there is further present a radially inner layer known as a “liner” and which has characteristics of impermeability in order to obtain the air-tightness in the tyre itself.

In a radially external position with respect to the belt structure, there is applied a tread band which is made of elastomer material and on which a tread surface which is intended for contact with the road surface is defined.

In order also to obtain adequate road grip on a wet road surface, the tyres have a tread band which is provided with grooves with various shapes and geometries and the main object of which is to allow the evacuate the water present between the surface of the tyre and the road surface during the mutual contact.

The grooves generally define on the tread band a plurality of blocks, each of which comprises a radially outer surface intended to contact with the road surface, and which therefore forms a portion of the tread surface of the tyre. Each block is further bounded at least partially by one or more walls which are defined by the grooves which surround it.

In some cases, a wall of a block, or a portion thereof, is connected to the tread surface of the block by means of a chamfer, which is typically formed by a plane, suitably slanted with respect to the wall and the tread surface, and which defines an edge of the block.

In the case of winter tyres, there are generally formed on the blocks of the tread band small recesses, called “sipes”, which extend from the tread surface of the tyre towards the inside of the block. The function of the sipes is to provide additional gripping elements in the case of travel on snowy surfaces and to retain a certain quantity of snow, thereby improving the grip with respect to the road surface. The sipes can have very varied and different configurations from each other, for example, they can have a rectilinear or curvilinear or undulating progression.

The term “circumferential” direction means a direction which is generally directed in the rotation direction of the tyre or, in any case, slightly slanted (at most by about 5°) with respect to the rotation direction of the tyre.

The term “axial” direction means a direction which is substantially parallel with the rotation axis of the tyre or, at most, slightly slanted (at most by about 5°) with respect to this rotation axis of the tyre. The axial direction is generally perpendicular to the circumferential direction.

The term “radial” direction means a direction perpendicularly intersecting the rotation axis of the tyre or at most which is slightly slanted (for example, at most by about 5°) with respect to the direction perpendicular to the rotation axis of the tyre.

The term “equatorial plane” of the tyre means an axial centre-line plane which is perpendicular to the rotation axis of the tyre.

The term “groove” means a recess which is formed in a tread band portion, and which extends in a main longitudinal direction and which has a width greater than or equal to 1.5 mm. Preferably, the groove has a depth of at least 3 mm.

The term “sipe” means a recess which is formed in a tread band portion, and which extends in a main longitudinal direction, and which has a width less than 1.5 mm.

The “longitudinal development direction” of the sipe is defined by the linear progression of the sipe in the region of the radially external surface of the block.

The term “block” means a tread band portion which is intended for contact with the road surface, and which is delimited over the entire periphery thereof by one or more grooves and where applicable by an axial end of the tread band.

Therefore, a block is considered to be both a tread band portion with a closed contour which is delimited by three or more grooves and a circumferential rib which is delimited by a pair of grooves which develop circumferentially around the tread band.

A “central block” is defined as a block which is not bounded by the axial ends of the tread band, while a block which is partially bounded by one of the axial ends of the tread band is defined as a “shoulder block”.

The term “wall” of a block means the surface which generally extends towards the tread surface portion of the block from a bottom of a groove bounding the block.

The term “edge” of a block means be the block region which joins a wall of the block with the tread surface portion of the block.

The edge may be formed by a corner if the wall intersects directly with the tread surface portion or can be formed by a connection surface which connects the wall to the tread surface portion, which is defined as a “chamfer”.

Two or more linear distances, such as, for example, two or more distances between sipes or between sipe elements, have a “substantially equal” length when the respective lengths differ from each other at most by an extent equal to 10% of the greatest length.

Two or more directions or two or more elements which extend in respective directions, such as, for example, two or more sipes or portions thereof, are “substantially parallel” when they are slanted relative to each other by an angle less than 10°, preferably less than 5°.

The inclination of a first direction with respect to a second direction, for example, the direction of a sipe portion with respect to a longitudinal development direction of a sipe, is defined by the acute angle which is formed by the first direction with the second direction. As a particular case, when the first direction is perpendicular to the second direction, the inclination is 90°.

Two or more directions or two or more elements which extend in respective directions, such as, for example, two or more sipes or portions thereof, are inclined in a “concordant manner” with respect to a further direction when the trend of the two or more directions is for all increasing or for all decreasing when considered on a Cartesian plane which contains said two or more directions and the axis of the abscissas of which is parallel to the other direction. For example, two different portions of a sipe which extends in a longitudinal development direction of the sipe are inclined in a concordant manner with respect to the longitudinal development direction of the sipe when both said portions of the sipe extend in respective directions which both increase or both decrease when considered on a Cartesian plane which has the axis of the abscissas parallel to the longitudinal development direction of the sipe.

Consequently, two or more directions or two or more elements which extend in respective directions, such as, for example, two or more sipes or portions thereof are inclined in a “discordant manner” when the trend thereof, when considered on this Cartesian plane, increases for one or more of said directions and decreases for one other or more than one of said directions.

The term “peak” which is defined on a sipe or a portion thereof means a maximum zone or a minimum zone which is defined on a linear section of said sipe or said portion thereof when the linear section is considered on a Cartesian plane, the axis of the abscissas of which is positioned in the longitudinal development direction of the sipe.

Two sipe portions, which are spaced apart from each other, are “substantially aligned” when, at least in the region of the respective ends thereof facing each other, the longitudinal directions thereof are:
aligned; or,
if the respective longitudinal directions are incident with respect to each other, then said longitudinal directions are inclined at an angle less than 10°, preferably less than 5°, or
if the respective longitudinal directions are parallel with each other, then said longitudinal directions are staggered by a value less than 1.5 mm.

Two sipes are “consecutive” when they are arranged on the tread surface of the block one following the other, considering a direction perpendicular to the longitudinal development direction of at least one of the two sipes.

The term “single-wave portion” of a sipe means a section of the linear trend of the sipe at the radially external surface of the block having a first peak and a second peak which are consecutive and opposite with respect to the longitudinal development direction of the sipe itself.

A sipe which is formed on a block separates this block into two block portions having respective mutually facing surfaces.

A sipe is defined to be “of the complex type” when at least one of the mutually facing surfaces of the block portions has at least one protuberance, while the other of these surfaces has a corresponding recess which is able to at least partially receive this protuberance. In other words, the respective projections in a plane perpendicular to the radial direction of the two block portions which are separated by the sipe are, in the region of the protuberance and the corresponding recess, at least partially overlapping.

In this manner, a relative movement of the two block portions in the radial direction is hindered by the interference between the two block portions in the region of the protuberance and the recess.

A sipe of the complex type is also known in the field as a “three-dimensional” sipe.

A sipe is defined as being “of the simple type” when there are not present on the mutually facing surfaces of the block portions protuberances and/or recesses which interfere with each other during the relative movement of the two block portions in the radial direction.

Examples of sipes which are configured in various manners are described, for example, in EP 3375639, U.S. Pat. No. 5,198,047, US 2021/0107319, EP 3867081A1, JP 6946658, JP 2018020689, U.S. Pat. No. 3,799,231, US20030029537, US 2005/0150581, EP 0598300, U.S. Pat. Nos. 5,327,953 and 5,591,280.

The Applicant has observed that the performance levels of a tyre on snowy road surfaces depend to a relevant extent on the quantity and the extent of the sipes which are formed on the blocks so that, for the same tread pattern, a block on which there are formed a plurality of sipes is able to provide better behaviour on snow.

However, the Applicant has further observed that the presence of the sipes weakens the structure of the block, making it less stiff and therefore decreasing the capacity of the block to withstand the external stresses, particularly the tangential stresses.

As a result of this weakening, in the event of braking, acceleration or travel on bends, the block may become deformed in a relevant manner, bringing about a partial raising of the block from the road surface with a resultant reduction of the contact area between the block and the road surface and consequently also of the overall friction force which is applied by the tyre to the road surface.

The Applicant has verified that the cause of this weakening of the block involves the fact that the sipe subdivides the block into two portions which, in the region of the sipe, can slide with respect to each other.

In particular, the Applicant has observed that this sliding occurs in a direction parallel with the separation surface of the two portions which can therefore always be considered to be a composition of a movement in two main directions which are defined on the separation surface: a direction which extends from the bottom of the sipe perpendicularly to the tread surface (generally coincident with the radial direction of the tread band) and a second direction parallel with the longitudinal development direction of the sipe.

The Applicant has verified that the resistance of the block in the region of the sipe can be improved by blocking or limiting to the greatest possible extent the possibility of mutual sliding in these two main directions.

The Applicant has observed that the sipes of the complex type which have a profile which is provided with protuberances and corresponding recesses, are able to oppose the mutual sliding of the block portions, particularly the movement in the first direction identified above. However, the provision of this type of profile is not always sufficient to effectively oppose the sliding actions in the above-mentioned second direction (parallel with the longitudinal development direction of the sipe), particularly in the region of the tread surface.

Therefore, the Applicant has observed that, in order to oppose this type of sliding, it is generally known to configure the sipe with an undulating linear progression, for example, in a zigzag manner.

The Applicant has further observed that, in order to obtain a sufficiently effective opposing action, this undulating linear progression has to extend over a large part of the longitudinal development of the sipe, providing multiple waves, with a generally symmetrical form.

However, the Applicant has verified that the opposing action to the tangential sliding of the block portions provided by this configuration is not always effective.

Therefore, the Applicant has perceived the need for providing a sipe which is particularly configured to make the opposing action to the sliding of the block portions more effective in a longitudinal development direction of the sipe without necessarily using an undulating trend with a high number of waves. In order to comply with this requirement, the Applicant has realized that the above-mentioned opposing action could be made more effective by conferring on the sipe a specific configuration, particularly in the region of the wave.

Finally, the Applicant has found that a sipe comprising a first and a second linear portion, which are rectilinear or slightly curvilinear and between which a single-wave portion is interposed, in turn comprising:
a first segment which is inclined with respect to the longitudinal direction of the sipe from the first linear portion as far as a first peak,
a second segment which is inclined with respect to the longitudinal direction of the sipe and which extends from the first peak as far as a second peak and
a third segment which is inclined with respect to the longitudinal direction and which extends from the second peak as far as the second linear portion,
wherein the second segment is more inclined with respect to the longitudinal direction with respect to the first segment and third segment, brings about effective opposition to the longitudinal sliding of the block portions which are separated by the sipe even with a reduced number of waves.

In particular, in a first aspect thereof, the invention relates to a tyre comprising a tread band and a tread surface which is radially external with respect to said tread band.

Preferably, a plurality of blocks are defined on said tread band.

Preferably, at least one first sipe which is open at said tread surface is formed on each block of said plurality of blocks.

Preferably, said first sipe is open at said tread surface so as to define a first longitudinal development direction of said first sipe.

Preferably, said first sipe comprises a first linear portion which substantially extends along said first longitudinal direction.

Preferably, said first linear portion is rectilinear or curvilinear with a minimum radius of curvature not less than 20 mm.

Preferably, said first sipe comprises a single-wave portion which extends in continuation of said first linear portion.

Preferably, said first sipe comprises a second linear portion which extends in continuation of said single-wave portion.

Preferably, said second linear portion is rectilinear or curvilinear with a minimum radius of curvature not less than 20 mm.

Preferably, said single-wave portion comprises a first segment which is inclined with respect to said first longitudinal direction.

Preferably, said first segment extends from said first linear portion as far as a first peak of said single-wave portion.

Preferably, said single-wave portion comprises a second segment which is inclined with respect to said longitudinal direction.

Preferably, said second segment extends from said first peak as far as a second peak of said single-wave portion.

Preferably, said second peak is defined at the opposite side to said first peak with respect to said first longitudinal direction.

Preferably, said single-wave portion comprises a third segment which is inclined with respect to said first longitudinal direction.

Preferably, said third segment extends from said second peak as far as said second linear portion.

Preferably, said second segment is inclined with respect to said first longitudinal direction at an angle greater than said first segment and said third segment.

The Applicant believes that, as a result of this specific configuration, it is possible to effectively oppose the sliding actions of the block portions which are separated by the sipe, even with a greatly reduced number of waves, for example, one or two in the entire sipe, allowing to obtain, for the same other conditions, a block which is more stiff and which is able to provide better behaviour on a dry road surface and also on an icy road surface.

The present invention, in the above-mentioned aspect, may have at least one of the additional preferred features indicated below.

In some embodiments, said first segment of said single-wave portion is inclined with respect to said first longitudinal direction at an angle between 20° and 45°, more preferably at about 24°.

In some embodiments, said third segment of said single-wave portion is inclined with respect to said first longitudinal direction at an angle between 20° and 45°, more preferably at about 24°.

Preferably, said first segment and said third segment of said single-wave portion are inclined in a concordant manner with respect to each other.

Preferably, said second segment of said single-wave portion is inclined in a discordant manner with respect to said first segment and said third segment of said single-wave portion.

In some embodiments, said first segment and said third segment of said single-wave portion are substantially parallel with each other.

In some embodiments, said second segment of said single-wave portion is inclined with respect to said first longitudinal direction at an angle between 60° and 90°, more preferably at about 80°.

In some embodiments, said first segment of said single-wave portion has a length substantially identical to said third segment of said single-wave portion.

Preferably, said first segment and said third segment have a length between 1.5 and 3 mm, more preferably of about 2 mm.

In some embodiments, the distance of said first peak from said first longitudinal direction is substantially identical to the distance of said second peak from said first longitudinal direction. Preferably, said distance is between 0.5 mm and 1.5 mm, more preferably of about 1 mm.

In some embodiments, said second linear portion has a length greater by at least 50%, preferably at least 100%, more preferably at least 200%, with respect to said first linear portion.

In this manner, the single-wave portion of the first sipe is greatly decentred with respect to the first and second portions, allowing the positioning thereof near an edge of the block, where it can perform the function thereof of stiffening the block in an even more effective manner.

In some embodiments, said first longitudinal development direction of the first sipe intersects with a first edge and a second edge of said block.

Preferably, said first linear portion extends towards said first edge.

Preferably, said second linear portion extends towards said second edge.

Preferably, the distance of said single-wave portion from said first edge measured along said first longitudinal direction is between 5% and 40%, more preferably between 25% and 35%, of the distance between said first edge and said second edge measured along said first longitudinal direction.

In this manner, the single-wave portion of the sipe is positioned near an edge of the block, where it can perform the function thereof of stiffening the block in a more effective manner.

Preferably, the distance of said single-wave portion from said second edge measured along said first longitudinal direction is at least double the distance of said single-wave portion from said first edge measured along said first longitudinal direction.

It may be noted that the distance of the single-wave portion from the first edge or from the second edge, respectively, is measured from the centre point of the single-wave portion at the first edge and at the second edge, respectively.

In some embodiments, said first linear portion is open at said first edge of said block.

Preferably, said first linear portion has a length between 2 and 5 mm.

Preferably, said first sipe, in the region of said first linear portion, has a depth less than the depth of said first sipe in the region of said single-wave portion.

In this manner, the stiffening effect of the block in the region of the first linear portion is advantageously increased.

In some embodiments, said second linear portion is open at said second edge of said block.

Preferably, said second linear portion has a length between 4 and 25 mm.

Preferably, said second linear portion is substantially aligned with said first linear portion along said first longitudinal direction.

In some embodiments, said first sipe comprises only one single-wave portion.

In some embodiments, there are further formed on said block a plurality of sipes which are configured similarly to the at least one first sipe.

In some particular embodiments, there is further formed on said block a second sipe which extends in a second longitudinal direction.

Preferably, said second sipe is consecutive to said first sipe.

Preferably, said second sipe is similar to said first sipe.

It may be noted that the second sipe is considered to be similar to the first sipe when, in the second sipe, there can be identified the same main elements, that is to say, a single-wave portion which is interposed between a first linear portion and a second linear portion, though with different dimensions.

In particular, said second sipe preferably comprises:
a first linear portion which substantially extends along said second longitudinal direction,
a single-wave portion which extends in continuation of said first linear portion, and
a second linear portion which extends in continuation of said single-wave portion.

Preferably, said first linear portion and said second linear portion of said second sipe are rectilinear or curvilinear with a minimum radius of curvature not less than 20 mm.

Furthermore, said single-wave portion of said second sipe preferably comprises:
a first segment which is inclined with respect to said second longitudinal direction and which extends from said first linear portion as far as a first peak of said second sipe,
a second segment which is inclined with respect to said second longitudinal direction and which extends from said first peak of the second sipe as far as a second peak which is defined at the opposite side to said first peak with respect to said second longitudinal direction and
a third segment which is inclined with respect to said second longitudinal direction and which extends from said second peak of the second sipe as far as said second linear portion of the second sipe.

Preferably, said second segment of said second sipe is inclined with respect to said second longitudinal direction at an angle greater than said first segment and said third segment of said second sipe.

Preferably, said second sipe has only one single-wave portion.

In some embodiments, said first longitudinal direction of said first sipe and said second longitudinal direction of said second sipe intersect with a first edge and a second edge of said block.

Preferably, the first linear portion of said first sipe is open at said first edge of said block.

Preferably, the single-wave portion of said first sipe has a distance from said first edge, measured along said first longitudinal direction of said first sipe, between 5% and 40%, more preferably between 25% and 35% of the distance between said first edge and said second edge measured along first longitudinal direction of said first sipe.

Preferably, the first linear portion of said second sipe is open at said second edge of said block.

Preferably, the single-wave portion of said second sipe has a distance from said second edge measured along said second longitudinal direction of said second sipe between 5% and 40%, more preferably between 25% and 35%, of the distance between said second edge and said first edge measured along said second longitudinal direction of said second sipe.

In this manner, the single-wave portion of the first sipe and the single-wave portion of the second sipe are positioned near opposite edges of the block, applying the stiffening action thereof to both sides of the block, so as to obtain adequate homogeneity of behaviour.

Preferably, said first longitudinal direction of said first sipe and said second longitudinal direction of said second sipe are substantially parallel with each other.

Preferably, said first peak, which is nearer the first edge, of said first sipe and said first peak, which is nearer the second edge of said second sipe are transversely offset at the same side with respect to said first longitudinal direction of said first sipe and said second longitudinal direction of said second sipe, respectively.

In other words, said first segment, second segment and third segment of said first sipe are inclined, with respect to said first longitudinal direction or said second longitudinal direction, in a discordant manner relative to said first segment, second segment and third segment of said second sipe, respectively.

In this manner, the respective second segments of the first and second sipes which are intended to provide the greatest opposing action to the longitudinal sliding of the block portions, are inclined in a discordant manner relative to each other so as to make the stiffness of the block substantially homogeneous when it is subjected to tangential stresses parallel with the first or second longitudinal direction which are orientated in opposite directions.

In some embodiments, there are formed on said block at least three mutually consecutive sipes, said at least three sipes being formed by an alternating succession of one of said first sipes and one of said second sipes.

In some embodiments, there are formed on said tread band central blocks, which are delimited only by one or more grooves.

In some embodiments, each central block of said tread band comprises at least one of said first sipes.

Preferably, all the sipes which are formed on the central blocks of said tread band having a length greater than a minimum predefined value are one of said first sipes or one of said second sipes and more preferably have only one single-wave portion.

Preferably, said minimum predefined value is between 5 mm and 15 mm, for example, about 10 mm.

In this manner, the sipe extends sufficiently far to be able to have the configuration with a single-wave portion interposed between two linear portions with suitable dimensions.

In some embodiments, two single-wave portions which are spaced apart from each other by said second linear portion are defined on said first sipe.

In some embodiments, there are formed on said tread band shoulder blocks which are partially delimited by an axial end of said tread band.

Preferably, said first sipe on which two single-wave portions are defined is formed on a shoulder block.

More preferably, each sipe which is formed on said shoulder blocks is one of said first sipes having two single-wave portions which are spaced apart from each other by said second linear portion.

In some embodiments, said at least one sipe is of the complex type.

The features and advantages of the invention will be better appreciated from the detailed description of a number of preferred embodiments thereof which are illustrated by way of non-limiting example with reference to the appended drawings, in which:

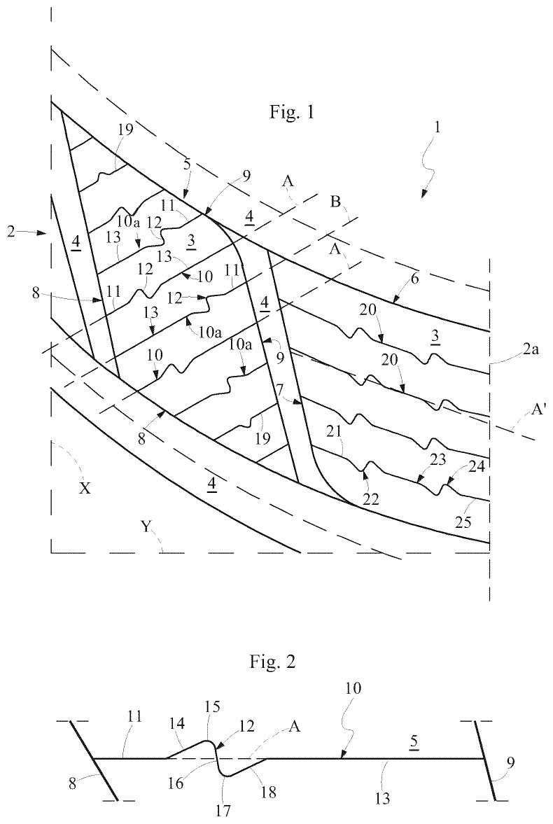

FIG. 1 is a schematic front view of a tread band portion of a tyre for vehicle wheels made according to the present invention;

FIG. 2 is a schematic front view, drawn to an enlarged scale, of a sipe which is formed on a block of the tyre of FIG. 1.

With reference to the appended Figures, there is generally designated 1 a tyre for vehicle wheels (not completely illustrated), which is made according to the present invention.

The tyre 1 has a conventional generally toroidal form which develops about a rotation axis, and which defines an axial direction Y of the tyre and which is passed through by an equatorial plane X which is perpendicular to the rotation axis.

The tyre 1 comprises a tread band 2, on which there is defined a tread surface 3 which is arranged in a radially external position with respect to the tread band 2 and which is intended for contact with a road surface.

The tyre 1 has, for example, a width with a nominal section of about 205 mm with a rim diameter of 16 inches.

There remain defined on the tread band 2 a central region which extends circumferentially and symmetrically around the equatorial plane X and a pair of shoulder regions which extend at the axially opposite sides of the central region, respectively, as far as the respective axial ends of the tread band 2.

There are formed on the tread band 2 a plurality of grooves which are all designated 4 and which delimit a respective plurality of central blocks 5 which are formed in the central region of the tread band 2 and a plurality of shoulder blocks 6 which are formed in the shoulder regions of the tread band 2 and which are delimited in the region of the axially outer side thereof by an axial end 2a of the tread band 2.

In the embodiment described here, the grooves 4 have a depth between 3 mm and 9 mm and a width between 2.5 mm and 9.5 mm.

By way of example, FIG. 1 schematically illustrates a central block 5 and a shoulder block 6, it being understood that the same considerations also apply similarly to all the other central blocks and the other shoulder blocks 6 which are formed in the tread band 2.

There is defined on the central block 5 a tread surface portion 3 which is defined on the radially external surface thereof and which is intended for contact with the road surface and a first edge 8 and a second edge 9, which is opposite the first edge 8, which join the tread surface portion 3 of the central block 5 to the walls of the respective grooves 4.

The first edge 8 and the second edge 9 together delimit the tread surface portion 3 of the central block 5 and can be chamfered completely or partially.

A plurality of first sipes 10 and a plurality of second sipes 10a, which alternate with each other, are formed on each central block 5.

The first sipes 10 extend in respective first longitudinal directions A while the second sipes 10a extend in respective second longitudinal directions B. All the first and second longitudinal directions A and B are substantially parallel with each other.

In the embodiment of a central block 5 illustrated in the Figures, the first longitudinal direction A and the second longitudinal direction B are inclined at about 60° with respect to the equatorial plane X, but there is provision for these directions to be able to have a different inclination, and to be parallel with the axial direction Y.

The first blocks 10 and the second blocks 10a are formed on the central block 5 in an alternating manner with each other and, furthermore, are preferably equidistant, for example, by an extent between about 5 mm and about 6 mm.

The first sipes 10 and the second sipes 10a are consecutive one after the other and have a similar formation, as better explained in detail below.

As can better be seen in FIG. 2, each first sipe 10 extends in the first longitudinal direction A in a manner passing over the central block 5 so as to be open at the first edge 8 and the second edge 9.

Each first sipe 10 comprises a first linear portion 11 which is open at the first edge 8, a single-wave portion 12 which extends in continuation of the first linear portion 11 and a second linear portion 13 which extends in continuation of the single-wave portion 12 and opens at the second edge 9.

Both the first linear portion 11 and the second linear portion 13 are substantially rectilinear and aligned in the first longitudinal direction A.

The second linear portion 13 may have a length greater than the first linear portion 11, preferably it is greater by at least 50%, more preferably by at least 100%, even more preferably by at least 200% of the first linear portion 11.

The first linear portion 11 has a length between 2 and 5 mm while the second linear portion 13 has a length between 4 and 25 mm.

The single-wave portion 12 comprises:
a first substantially rectilinear segment 14 which extends from the first linear portion 11 as far as a first peak 15 and which is inclined with respect to the first longitudinal direction A;
a second substantially rectilinear segment 16 which extends from the first peak 15 as far as a second peak 17, which is defined at the opposite side to the first peak 15 with respect to the first longitudinal direction A; and
a third substantially rectilinear segment 18 which extends from the second peak 17 as far as the second linear portion 13 and which is inclined with respect to the first longitudinal direction A.

The first segment 14 and the third segment 18 are substantially parallel with each other and are inclined with respect to the first longitudinal direction A at about 30°. Furthermore, the first segment 14 and the third segment 18 have a substantially equal length of about 2 mm.

The second segment 16 is inclined by about 80° with respect to the first longitudinal direction A in a discordant manner with respect to the first segment 14 and the third segment 18 with respect to the first longitudinal direction A.

The distances of the first peak 15 and the second peak 17 from the first longitudinal direction A are substantially identical and equal to about 1 mm, respectively.

The single-wave portion 12 is therefore substantially symmetrical with respect to the point where the second segment 16 intersects the first longitudinal direction A which is defined by the first and second linear portions 11 and 13.

Each first sipe 10 has a width of about 0.5 mm and a variable depth between 3 mm, at the end regions thereof, in particular at the first linear portion 11, and about 7 mm, at the single-wave portion 12 and the centre region of the first sipe 10.

Each first sipe 10 is further preferably of the complex type, having along the radial profile thereof one or more protuberances and corresponding recesses which impede the free sliding in the radial direction of the portions of the central block 5, which are separated by the same first sipe 10.

As set out above, the second sipes 10a are similar to the first sipes 10. In fact, in each second sipe 10a there can be identified a first linear portion 11 which is followed by a single-wave portion 12 and therefore by a second linear portion 13, which is longer than the first linear portion 11.

Each second sipe 10a differs from any first sipe 10 in that in the second sipe 10a the first linear portion 11 is open at the second edge 9 (and at the first edge 8) and the second linear portion 13 is open at the first edge 8 (and at the second edge 9).

As a result of the fact that the first sipes 10 are arranged in an alternating manner on the second sipes 10a, the single-wave portions 12 of the first sipes 10 and the second sipes 10a are positioned in an alternating manner near the first edge 8 and near the second edge 9 so as to stiffen both the edges of the central block 5 in a substantially homogeneous manner.

Furthermore, the first peak 15 of each first sipe 10 and the first peak 15 of each second sipe 10a are offset transversely at the same side with respect to the respective longitudinal direction A and B.

This configuration is obtained by configuring the sipes 10 and 10a in such a manner that the first segment 14, the second segment 16 and the third segment 18 of the first sipe 10 are inclined, with respect to the first longitudinal direction A, in a discordant manner with respect to the first segment 14, the second segment 16 and third segment 18 of the second sipe 10a.

Preferably, all the sipes which are formed on a central block 5 are first sipes 10 or second sipes 10a, provided that the overall length thereof is greater than a minimum value of about 10 mm.

Where there is provided on the central block 5 a sipe with smaller dimensions, as in the case of the corner regions illustrated in FIG. 1, where these sipes are designated 19, the sipe may have a different configuration, for example, rectilinear or undulating with a single peak.

There are formed on the shoulder block 6 a plurality of third sipes 20 which extend parallel with each other in a respective third longitudinal development direction A′ which is generally different from the first and second longitudinal directions A and B.

The third sipes 20 are similar to the first sipes 10 and the second sipes 10a which are formed on the central block 5, but, unlike the first sipes 10 and the second sipes 10a which have only one single-wave portion 12, the third sipes 20 have two single-wave portions. In fact, each third sipe 20 may be considered to be a first sipe 10 having two single-wave portions.

Therefore, each third sipe 20 comprises a first linear portion 21 which is open at a first edge 7 of the shoulder block 6, a first single-wave portion 22, which extends in continuation of the first linear portion 21, a second linear portion 23, which extends in continuation of the first single-wave portion 22, a second single-wave portion 24 which extends in continuation of the second linear portion 23 and a third linear portion 25 which extends in continuation of the second single-wave portion 24 as far as the axial end 2a of the tread band 2.

It may be noted that the third linear portion 25 may be considered to be the first linear portion of the second single-wave portion 24, the second linear portion 23 being common to both the single-wave portions 22 and 24.

The single-wave portions 22 and 24 of the sipes 20 are entirely similar to the single-wave portion 12 which is described in detail above with reference to the first and second sipes 10, 10a.

The Applicant has verified that a central block 5 and a shoulder block 6 which are provided with a plurality of sipes as described above has optimum resistance to the tangential stresses which are directed in the longitudinal development direction, improving the performance levels on icy roads and on dry roads.

Naturally, in order to comply with specific and contingent application requirements, a person skilled in the art may apply to the above-described invention additional modifications and variants which are still included within the scope of protection as defined by the appended claims.

For example, the number of first and/or second sipes which are present on a central block may be different from the number described above, and on a central block there may also be present sipes with different configurations or sipes with a plurality of single-wave portions, such as, for example, the third sipes described here in the shoulder block.

1.-27. (canceled)

28. A tyre comprising:
a tread band,
a tread surface radially external with respect to said tread band,
a plurality of blocks defined on said tread band, and
at least one first sipe formed on each block of said plurality of blocks, said first sipe being open at said tread surface to define a first longitudinal development direction of said first sipe, said first sipe comprising:
a first linear portion which extends along said first longitudinal direction,
a single-wave portion which extends in continuation of said first linear portion, and
a second linear portion which extends in continuation of said single-wave portion,
wherein said first linear portion and said second linear portion are rectilinear or curvilinear with a minimum radius of curvature not less than 20 mm,
wherein said single-wave portion comprises:
a first segment inclined with respect to said first longitudinal direction at a first segment angle and which extends from said first linear portion to a first peak,
a second segment inclined with respect to said first longitudinal direction at a second segment angle and which extends from said first peak to a second peak, the second peak defined at an opposite side to said first peak with respect to said first longitudinal direction and
a third segment inclined with respect to said first longitudinal direction at a third segment angle and which extends from said second peak to said second linear portion,
wherein said second segment angle is greater than said first segment angle and said third segment angle.

29. The tyre according to claim 28, wherein said first segment angle and said third segment angle are each between 20° and 45°.

30. The tyre according to claim 29, wherein said second segment angle is between 60° and 90°.

31. The tyre according to claim 30, wherein said first segment and said third segment of said single-wave portion are substantially parallel.

32. The tyre according to claim 31, wherein a length of said first segment of said single-wave portion is substantially identical to a length of said third segment of said single-wave portion.

33. The tyre according to claim 32, wherein a distance of said first peak from said first longitudinal direction is substantially identical to a distance of said second peak from said first longitudinal direction.

34. The tyre according to claim 33, wherein a length of said second linear portion is greater by at least 50% than a length of said first linear portion.

35. The tyre according to claim 34, wherein the length of said second linear portion is greater by at least 100% than the length of said first linear portion.

36. The tyre according to claim 35, wherein the length of said second linear portion is greater by at least 200% than the length of said first linear portion.

37. The tyre according to claim 36, wherein said first longitudinal development direction of the first sipe intersects with a first edge and a second edge of a block of said plurality of blocks, said first linear portion extending towards said first edge and said second linear portion extending towards said second edge, and wherein a distance of said single-wave portion from said first edge measured along said first longitudinal direction is between 5% and 40% of a distance between said first edge and said second edge measured along said first longitudinal direction.

38. The tyre according to claim 37, wherein a distance of said single-wave portion from said second edge measured along said first longitudinal direction is at least double the distance of said single-wave portion from said first edge measured along said first longitudinal direction.

39. The tyre according to claim 38, wherein said first linear portion is open at said first edge of said block.

40. The tyre according to claim 39, wherein the length of said first linear portion is between 2 and 5 mm.

41. The tyre according to claim 40, wherein a depth of said first sipe in a region of said first linear portion is less than a depth of said first sipe in a region of said single-wave portion.

42. The tyre according to claim 41, wherein said second linear portion is open at said second edge of said block.

43. The tyre according to claim 42, wherein the length of said second linear portion is between 4 and 25 mm.

44. The tyre according to claim 43, wherein said second linear portion is substantially aligned with said first linear portion along said first longitudinal direction.

45. The tyre according to claim 44, wherein said first sipe comprises only one single-wave portion.

46. The tyre according to claim 45, wherein a second sipe is formed on said block, the second sipe extending in a second longitudinal direction and being consecutive to said first sipe, the second sipe comprising:
a first linear portion which extends along said second longitudinal direction,
a single-wave portion which extends in continuation of said first linear portion, and
a second linear portion which extends in continuation of said single-wave portion, wherein said first linear portion of said second sipe and said second linear portion or said second sipe are rectilinear or curvilinear with a minimum radius of curvature not less than 20 mm.

47. The tyre according to claim 46, wherein said first sipe and said second sipe each have only one single-wave portion.

48. The tyre according to claim 47, wherein said first longitudinal direction of said first sipe and said second longitudinal direction of said second sipe both intersect with the first edge and the second edge of said block, and wherein:
the first linear portion of said second sipe is open at said second edge of said block, and
the single-wave portion of said second sipe has a distance from said second edge measured along said second longitudinal direction of said second sipe between 5% and 40% of a distance between said second edge and said first edge measured along said second longitudinal direction of said second sipe.

49. The tyre according to claim 48, wherein said first longitudinal direction of said first sipe and said second longitudinal direction of said second sipe are substantially parallel with each other.

50. The tyre according to claim 49, wherein said first peak, which is nearer the first edge, of said first sipe and a first peak, which is nearer the second edge, of said second sipe are transversely offset with respect to said first longitudinal direction of said first sipe and said second longitudinal direction of said second sipe, respectively, and are offset in a same transverse direction relative to said first longitudinal direction of said first sipe and said second longitudinal direction of said second sipe, respectively.

51. The tyre according to claim 50, wherein at least three mutually consecutive sipes are formed on said block, said at least three sipes configured in an alternating succession of one of said first sipes and one of said second sipes.

52. The tyre according to claim 51, wherein central blocks are formed on said tread band, the central blocks delimited by one or more grooves, each central block comprising at least one of said first sipes.

53. The tyre according to claim 52, wherein all sipes formed on the central blocks of said tread band having a length greater than a minimum predefined value are one of said first sipes or one of said second sipes and have only one single-wave portion.

54. The tyre according to claim 28, wherein shoulder blocks are formed on said tread band, the shoulder blocks partially delimited by an axial end of said tread band, and wherein each sipe which is formed on said shoulder blocks is one of said first sipes having two single-wave portions, the two single-wave portions being spaced apart from each other by said second linear portion.
